(19) United States
(12) Patent Application Publication
(10) Pub. No.: US 2009/0050606 A1
(43) Pub. Date: Feb. 26, 2009

(54) Changeable welding head assembly

(76) Inventor: David Colbert Smith, Fort Pierce, FL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/894,920

(22) Filed: Aug. 22, 2007

(51) Int. Cl. B23K 9/16

(52) U.S. Cl. 219/74

(57) ABSTRACT

A welding head assembly for use with a torch. The torch has an electrical contact and a gas passage for operatively supporting an electrode with a working end of the electrode at a first location. The welding head assembly has a body, a gas flow path, a gas outlet, an electrical flow path, and an electrode. The body extends between a first end and a second end where the first end is releasably coupled to the torch. The gas flow path and electrical flow path extend between the first and the second end. The electrode is located at the second end remote from the first location.

### BACKGROUND OF THE INVENTION

1. Field of the Invention

This invention pertains to welding torches and, more particularly, to welding torches with changeable welding head assemblies.

2. Background Art

Welding torches are used to join various materials, including a variety of different types of metals. Among the different forms of welding are MMA, MIG, and TIG, each of which is chosen depending on the type of metal and the type weld desired.

These different forms of welding include different components, such as consumable or non-consumable electrodes, different forms of inert gases, working gases, and the like. For example, with tungsten inert gas welding (TIG), the electrodes are non-consumable. An inert or semi-inert gas mixture is used together with a filler material to join pieces of metal. The torches used for welding are connected to lines to supply the required materials as well as coolants. For example, with TIG welding, a torch is connected to a power source to supply electricity, a gas source to supply the inert or semi-inert gas, and a coolant supply for providing water or other cooling material to the torch.

Oftentimes, the design of a torch is such that it is unsuitable for accessing certain work regions, such as small openings in workpieces, as shown in FIG. 1 herein. Therefore, the operator generally must carry an additional torch and supply setup or must change out the torch for a smaller torch to access the desired welding site. It can be expensive and cumbersome to carry multiple complete torch and supply setups. To change torches, the operator oftentimes must shut off the supplies, including those for electricity, gas, coolant, and any other supply sources, preparatory to the change. Furthermore, the operator may be working remotely from the supply sources and therefore may have to leave the work area to go to the location of the supply sources, thereby wasting additional valuable time.

### SUMMARY OF THE INVENTION

In one form, a welding head assembly is provided for use with a torch having an electrical contact and a gas passage for operatively supporting an electrode with a working end of the electrode at a first location. The welding head assembly has a first end and a second end. The first end has an electrical input and a gas inlet. When coupled to the torch, the first end provides a connection between the electrical contact and the electrical input and a fluidic connection between the gas passage and the gas inlet. The second end has a gas outlet at which end a working end of an electrode is operatively maintained at a second location that is remote from the first location. The welding head assembly defines a gas flow path extending from the gas inlet to the gas outlet and an electrical flow path extending between the electrical input and the electrode.

The invention is also directed to a welding head assembly for use with a torch having an electrical contact and a gas passage for operatively supporting an electrode with a working end of the electrode at a first location. The welding head assembly has a body, a gas flow path, a gas outlet, an electrical flow path, and an electrode. The body extends between a first end and a second end. The first end is configured to connect to the torch while the second end is located remotely from the torch. The gas flow path extends from the first end to the second end and is in fluid communication with the gas passage. The gas outlet is located at the second end and is in fluid communication with the gas flow path. The electrical flow path extends from the first end to the second end and is electrically coupled to the electrical contact. The electrode is located at the second end and is electrically coupled to the electrical flow path.

In another form, a torch and a weld head assembly are provided in combination. The torch has an electrical contact and a gas passage and operatively supports an electrode with a working end of the electrode at a first location. The welding head assembly has a first end configured to connect to the torch, a second end located remotely from the torch, and a body extending between the first and second ends. The first end has an electrical input and a gas inlet. The first end provides a connection between the electrical contact and the electrical input and a fluidic connection between the gas passage and the gas inlet. The second end has an electrode and a gas outlet. The body has a gas flow path extending from the gas inlet to the gas outlet and an electrical flow path extending between the electrical input and the electrode.

According to one form, the welding head assembly further has a locking clamp at the first end to releasably maintain the welding head assembly in a desired orientation on the torch.

In one form, the welding head assembly further has a chuck located at the second end to operatively maintain the working end of the electrode.

According to one form, the welding head assembly has a nozzle located at the second end to direct the gas at the gas outlet.

In one form, the body has an interior space which defines the gas flow path.

According to one form, the body has a non-conducting material covering the body.

In one form, the first end is threaded to releasably couple the welding head assembly at the first end to the torch.

Other objects, features, and advantages of the invention will become apparent from a review of the entire specification, including the appended claims and drawings.

### BRIEF DESCRIPTION OF THE DRAWINGS

FIG. 1 is a perspective view of a conventional torch situated adjacent to a workpiece;

FIG. 2 is a perspective view of a torch with the inventive welding head assembly mounted thereon and situated to weld a workpiece as in FIG. 1;

FIG. 3 is an exploded view of the torch and welding head assembly;

FIG. 4 is an exploded view of a an end of a modified form of the welding head assembly; and

FIG. 5 is an enlarged, cross-sectional view of the welding head assembly taken along line 5-5 of FIG. 2.

### DETAILED DESCRIPTION OF THE DRAWINGS

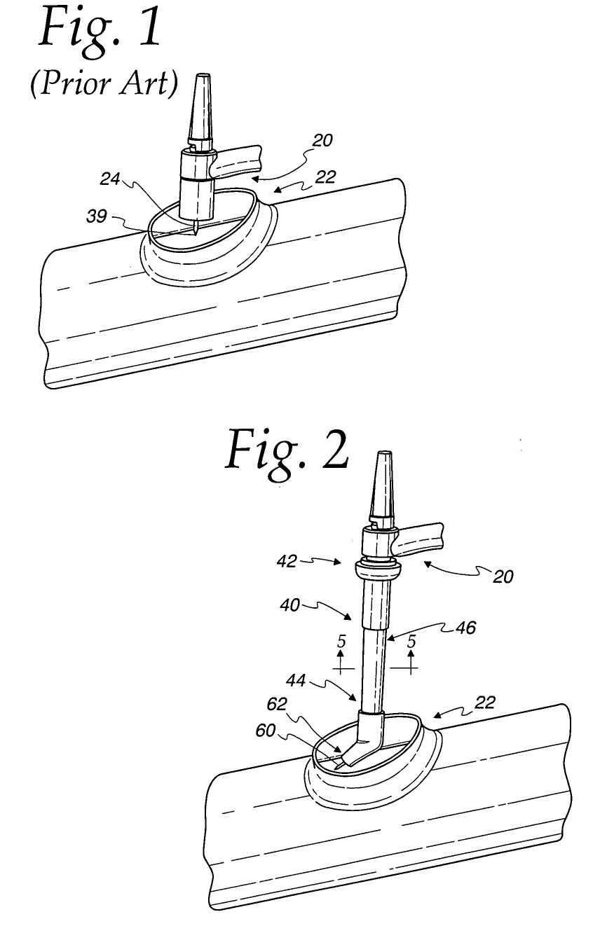

In FIG. 1, a welding torch 20 is shown adjacent an exemplary workpiece 22. The torch 20 is a conventional torch, such as a TIG welding torch having an electrode 24 to provide an arc between the torch 20 and the workpiece 22. As seen in FIGS. 1 and 3, the torch 20 has an electrical contact 26 through which the electrode 24 is supplied electricity. The electrode 24 is maintained operatively upon the torch 20 at the contact 26 as by utilizing internal threads 27 thereon. Furthermore, the torch 20 includes a gas passage 28 for directing a gas to adjacent the electrode 24. As seen in FIG. 3, the torch 20 also has supply lines, among which are an electric power supply line 30, gas supply line 32, and coolant supply line 34, respectively in communication with an electric power supply E, a gas supply G, and a coolant supply C.

The conventional torch 20 has a number of limitations inherent to its geometry. As an example, as seen in FIG. 1, the torch 20 is not suitable for welding on the inside surface of a small diameter workpiece 22 since the working end 39 of the electrode 24, which resides at a predetermined location with respect to the torch 20, cannot be directed into the workpiece 22 and angled appropriately to produce a weld at this site.

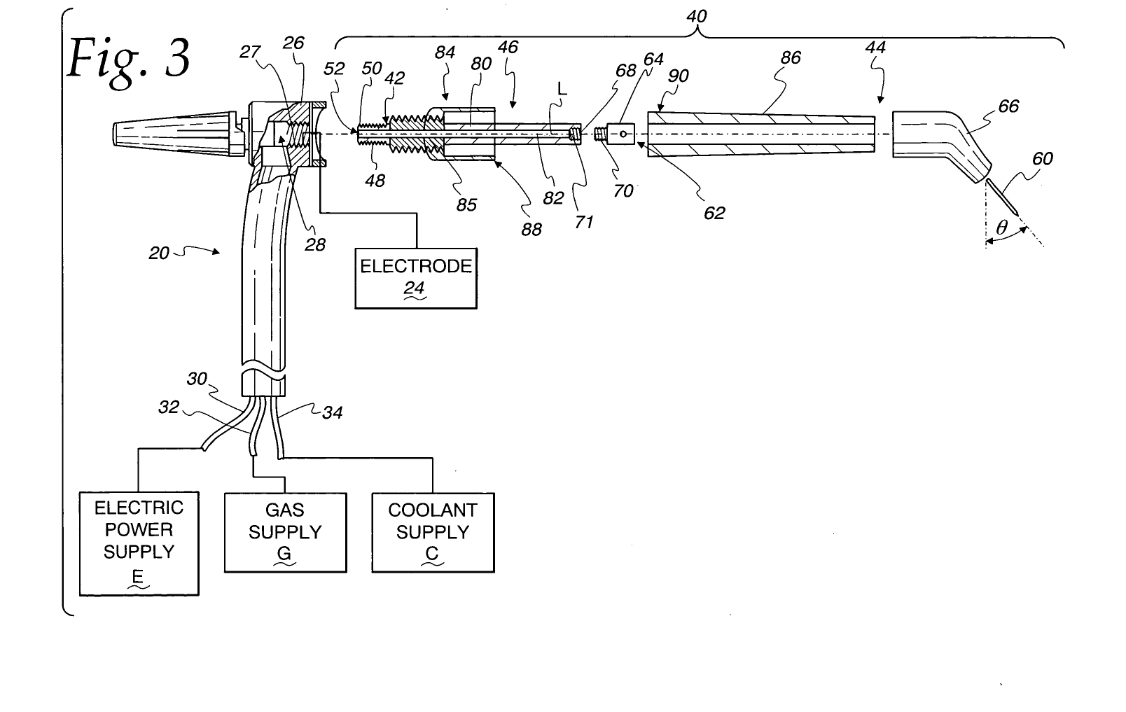

A welding head assembly 40, according to the invention, can be utilized to, among other things, weld the inside of the workpiece 22, as shown in FIG. 2. The electrode 24 and other associated components can be separated from the torch 20 so that the welding head assembly 40 can be operatively connected to the torch 20. As best seen in FIGS. 2 and 3, the welding head assembly 40 has a first end 42, a second end 44, and a body 46 extending between the first and second ends 42,44. The first end 42 is configured to connect to the torch 20. For example, the first end 42 may include external threads 48 to mate with the threads 27 on the electrical contact 26. The working head assembly 40 may thus be selectively released from the torch 20.

The first end 42 has an electrical input 50 and a gas inlet 52. The first end 42, and more specifically the electrical input 50, provides a connection from the electrical contact 26 to the welding head assembly 40 with the welding head assembly 40 operatively connected to the torch 20. Furthermore, the first end 42, and more specifically the gas inlet 52, provides a fluidic connection from the gas passage 28 to the welding head assembly 40 with the welding head assembly 40 operatively connected to the torch 20.

It should be understood that the first end 42 can take a variety of forms for connecting the torch 20 to the welding head assembly 40, and need not include threads 48. Other suitable mechanisms for connecting the torch 20 and welding head assembly 40 would be well known to those skilled in this art. Similarly, other forms of the electrical input 50 and the gas connection 52 are also contemplated.

The second end 44 has an electrode 60 and a gas outlet 62. Furthermore, the second end 44 may include a chuck 64 and a cup/nozzle 66. The electrode 60 may be the same electrode as identified by the reference numeral 24 used in the torch 20, or it may be a different electrode. When used with the welding head assembly 40, the working end of the electrode 60 is located remotely from the location of the working end of the electrode 24 that is used directly with the torch 20, as in FIG. 1. In one form, the electrode 60 is separate from the electrode 24 such that the electrode 60 need not be changed back and forth when attaching the weld head assembly 40 to, and separating the welding head assembly 40 from, the torch 20.

Generally, the working end of the electrode 60 is operatively maintained at the second end 44 by the chuck 64. The chuck 64 may be affixed to the second end 44 such as at a complementary aperture 68, which may be threaded. In this form, the chuck 64 has external threads 70 to engage with internal threads 71 within the aperture 68. It should be understood that the chuck 64 may be coupled to the second end 44 in other manners as would be understood by those skilled in the art. As one example, the chuck 64 may be permanently affixed at the second end 44.

It should also be understood that the chuck 64 may include additional structure, such as a collet (not shown) or other structure, likewise known to those skilled in the art. With the form of the chuck 64 and second end 44, as illustrated in FIG. 3, the chuck 64 retains the electrode 60 at an angle θ to a line L representing the lengthwise extent of the body 46.

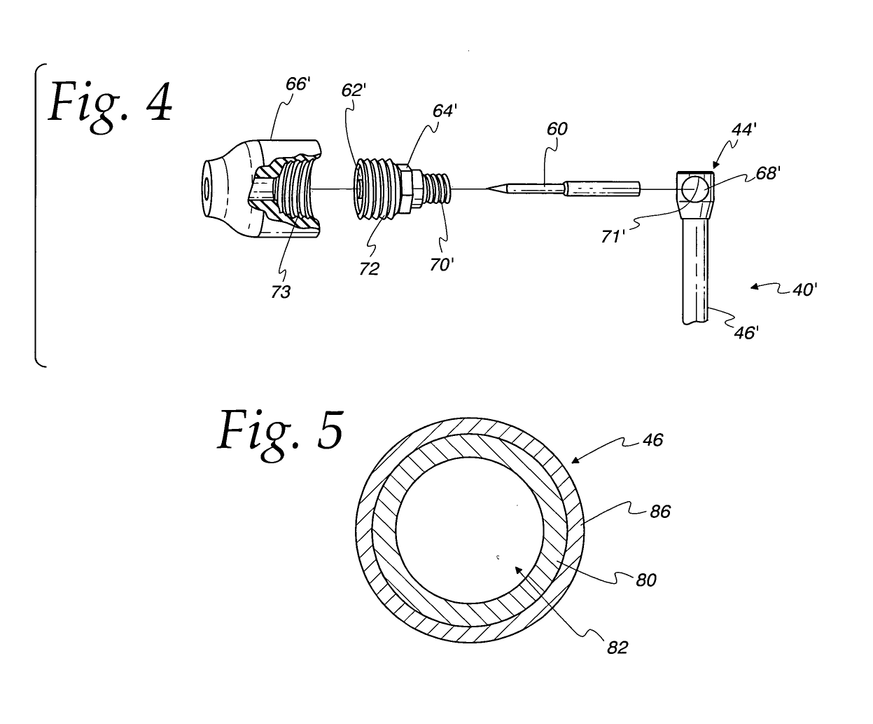

Another form of the chuck 64′ and the second end 44′ is illustrated on a modified form of the welding head assembly 40′ in FIG. 4, wherein the chuck 64′ retains the electrode 60 at another angle. It should be understood that the chucks 64, 64′ and second ends 44, 44′ can be modified to retain the electrode 60 at any desired orientation/angle for working on a particular workpiece. The chucks 64, 64′ may have a variety of shapes, sizes and angles to retain a variety of sized electrodes 60, as desired.

The cups 66, 66′, shown respectively in FIGS. 3 and 4, can be used, as understood by those skilled in this art, to direct and/or retain a gas (inert, semi-inert, or otherwise) around the electrode 24. The cups 66, 66′ can also take a variety of shapes, sizes and angles to cooperate with the chucks 64, 64′. Additionally, it should be understood that the chucks 64, 64′ and nozzles 66, 66′ may be each interchangeable with different chucks and nozzles such that the same welding head assembly 40, 40′ can be used for a variety of different jobs requiring electrodes of different sizes and to be used in different orientations.

Furthermore, the cups 66, 66′ may attach to the chucks 64, 64′ and/or second ends 44, 44′ in a variety of different manners as understood by those skilled in the art. For example, in FIG. 4, the chuck 64′ includes external threads 72 to cooperate with internal threads 73 on the cup 66′ to retain the cup 66′. The chuck 64′, which defines a gas outlet 62′, may have external threads 70′ to engage internal threads 71′ surrounding the aperture 68′ at the second end 44′ of the body 46′.

The exemplary body 46, as seen additionally in FIG. 5, extends between the first and second ends 42,44 and may be of any desired length such that the second end 44 is remote from the first end 42. In one form, the body 46 has a substantially hollow component 80 bounding an interior space/passage 82. In this form, the body 80 is made of a conductive material such that it provides an electrical flow path extending from the first end 42 to the second end 44. The interior space/passage 82 provides a gas flow path extending from the first end 42 to the second end 44. However, it should be understood that the body 46 may take other forms, such as a solid body with an added gas flow path (not shown). Furthermore, it should be understood that the body 46 may take a variety of shapes and sizes as desired. For example, the body 46 may be substantially straight, may be curved and/or may include a sharp bend.

The body 46 may also include a locking clamp 84, as shown in FIG. 3. The clamp 84 may take the form of a cup or collet body and can be used to maintain the body 46 at a desired operative orientation with respect to the torch 20. For example, the clamp 84 may be threaded on an enlarged diameter portion 85 of the body 46 with the first end 42 threaded into the torch 20. In this form, the clamp 84 can be turned to tighten against the torch 20, thereby retaining the body 46 at a desired angular orientation with respect to the torch 20 around the line L.

Furthermore, the body 46 may include a non-conducting or insulating cover 86 surrounding some, and more preferably substantially all, of the body 46, where it would otherwise be directly exposed, as shown also in FIG. 5. The insulating cover 86 can be used to prevent unwanted electrical contact between the body 80 and a user, and other external surfaces. The locking clamp 84 has an end portion at 88 that receives, and protectively surrounds, an end 90 of the cover 86. This avoids having exposed surfaces that might cause unwanted grounding or electrical shock.

In one form, gas flows and electricity conducts from the torch 20 through the first end 42 of the body 46 to the second end 44 thereof to weld a workpiece 22. In this form, electricity conducts from the electrical contact 26 to the electrical input 50, through the body 80 to the chuck 64, and ultimately to the electrode 60, whereby it can provide an electrical arc at the workpiece 22. Similarly, gas flows from the gas glow path 28 to the gas inlet 52, through the gas flow path 82 to the chuck 64, and ultimately through the gas outlet 62 adjacent the electrode 60.

It should be understood that the welding head assembly 40 can be utilized in a manner that it becomes unnecessary to change out the supply lines 30,32,34 from the torch 20 to another torch (not shown). Instead, the welding head assembly 40 is coupled to the torch 20 to enable the torch 20 and selected welding head assembly 40 to be used to adapt to different encountered field conditions. Different types of working head assemblies may be kept on hand to meet all, or most, anticipated demands.

It should also be understood that the welding head assembly 40 can be used with a variety of different sizes and types of torches. For example, the welding head assembly 40 can be sized to work with large and small torches. Furthermore, the welding head assembly 40 can be used with different forms of welding torches such as TIG, and the like. The welding head assembly 40 can be used on air cooled, water cooled, large, small, and high or low amp TIG torches.

It should be appreciated that for all of the disclosed embodiments there are many possible modifications contemplated. Additionally, it should be understood that the embodiments described herein may be utilized with a variety of additional optional components understood by those skilled in the art.

1. A welding head assembly for use with a torch comprising an electrical contact and a gas passage for operatively supporting an electrode with a working end of the electrode at a first location, the welding head assembly comprising:
a first end having an electrical input and a gas inlet, when coupled to the torch, the first end provides a connection between the electrical contact and the electrical input and a fluidic connection between the gas passage and the gas inlet; and
a second end having a gas outlet and at which a working end of an electrode is operatively maintained at a second location that is remote from the first location,
the welding head assembly defining a gas flow path extending from the gas inlet to the gas outlet and an electrical flow path extending between the electrical input and the electrode.

2. The welding head assembly of claim 1 further comprising a locking clamp at the first end to releasably maintain the welding head assembly in a desired orientation on the torch.

3. The welding head assembly of claim 1 further comprising a chuck located at the second end to operatively maintain the working end of the electrode.

4. The welding head assembly of claim 1 further comprising a nozzle located at the second end to direct the gas at the gas outlet.

5. The welding head assembly of claim 1 wherein the welding head comprises a hollow body extending between the first end and the second end, the hollow body having an interior space defining the gas flow path.

6. The welding head assembly of claim 5 wherein the hollow body further includes a non-conducting material covering the hollow body.

7. The welding head assembly of claim 1 wherein the first end is threaded to releasably couple the welding head assembly at the first end to the torch.

8. A welding head assembly for use with a torch comprising an electrical contact and a gas passage for operatively supporting an electrode with a working end of the electrode at a first location, the welding head assembly comprising:
a body extending between a first end and a second end, the first end configured to connect to the torch, the second end located remotely from the torch;
a gas flow path extending from the first end to the second end and in fluid communication with the gas passage;
a gas outlet located at the second end and in fluid communication with the gas flow path;
an electrical flow path extending from the first end to the second end and electrically coupled to the electrical contact; and
an electrode located at the second end and electrically coupled to the electrical flow path.

9. The welding head assembly of claim 8 further comprising a locking clamp at the first end to releasably maintain the welding head assembly in a desired orientation on the torch.

10. The welding head assembly of claim 8 further comprising a chuck located at the second end to operatively maintain the working end of the electrode.

11. The welding head assembly of claim 8 further comprising a nozzle located at the second end to direct the gas at the gas outlet.

12. The welding head assembly of claim 8 wherein the body has an interior space defining the gas flow path.

13. The welding head assembly of claim 8 wherein a non-conducting material is exposed on the body.

14. The welding head assembly of claim 8 wherein the first end is threaded to releasably couple the welding head assembly at the first end to the torch.

15. In combination:
a torch comprising an electrical contact and a gas passage for operatively supporting an electrode with a working end of the electrode at a first location; and
a welding head assembly comprising a first end configured to connect to the torch, a second end located remotely from the torch, and a body extending between the first and second ends,
the first end comprising an electrical input and a gas inlet, the first end providing a connection between the electrical contact and the electrical input and a fluidic connection between the gas passage and the gas inlet,
the second end having an electrode and a gas outlet,
the body having a gas flow path extending from the gas inlet to the gas outlet and an electrical flow path extending between the electrical input and the electrode.

16. The combination of claim 15 further comprising a locking clamp at the first end to releasably maintain the welding head assembly in a desired orientation on the torch.

17. The combination of claim 15 further comprising a chuck located at the second end to operatively maintain the working end of the electrode.

18. The combination of claim 15 further comprising a nozzle located at the second end to direct the gas at the gas outlet.

19. The combination of claim 15 wherein the body has an interior space defining the gas flow path.

20. The combination of claim 15 wherein a non-conducting material is exposed on the body.

21. The combination of claim 15 wherein the first end is threaded to releasably couple the welding head assembly at the first end to the torch.
